(19) United States
(12) Patent Application Publication
(10) Pub. No.: US 2006/0151709 A1
(43) Pub. Date: Jul. 13, 2006

(54) Device and method for determining an allowed expsure of human skin to uv radiation

(76) Inventor: Markus Hahl, Peiss (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/562,585

(22) PCT Filed: Jul. 1, 2004
(86) PCT No.: PCT/DE04/01391

§ 371 Date: Dec. 28, 2005

(30) Foreign Application Priority Data
Jul. 2, 2003 (DE) 10329915.7

(51) Int. Cl. G01J 1/42

(52) U.S. Cl. 250/372

(57) ABSTRACT

The aim of the invention is to be able to produce verifiable and reproducible information regarding the maximum radiation dose and/or the maximum exposure time of a subject to a UV radiation source. Said aim is achieved by a device for determining the allowed exposure time and/or radiation dose, comprising a UV emitter (7) for emitting a UV radiation, a UV sensor (8) for receiving the UV radiation reflected in and/or on the skin, and an evaluation unit for determining the radiation absorption. Particularly such a device individually measures the absorption of the erythema-effective UV radiation in a layer of a subject's skin, which is subject to hyperkeratosis, a UV radiation threshold value being assigned.

The invention relates to measuring devices and a method for determining the allowable UV exposure time and/or UV radiation dose of human skin, especially in connection with the use of tanning beds in tanning salons, but also in preparation, for example, for a vacation in the mountains, in southern regions, etc.

Many people are unaware that the skin can suffer damage that is often severe and irreversible merely from a long weekend or even a single day of excessive exposure to the sun. In particular, persons with pale skin at the end of winter are extremely endangered even in Central European summer.

To prevent skin damage, especially in the form of sunburn, it is often recommended that a tanning salon be visited before a planned vacation or trip for the purpose of acclimating the skin to sun exposure by irradiation on a tanning bed, especially with light with a high UV radiation component, which causes the skin to develop natural protection from UV radiation by tanning.

Besides this protective function, many people find tanned skin esthetically pleasing and therefore go to tanning salons for this reason alone.

UV radiation produced by the sun or a tanning bed is usually classified as UVA radiation with wavelengths of 315 (320) to 380 (400) nm, UVB radiation with wavelengths of 280 to 315 (320) nm, and UVC radiation with wavelengths of 100-280 nm.

UVA radiation darkens uncolored melanin precursors, dopamines, present in the skin, stimulates Leight repair, i.e., the repair of ultraviolet-induced nucleic acid damage, and initiates photorecovery. On the other hand, however, it enhances the harmful biological effects of ultraviolet B radiation.

UVA radiation, which is often further classified as UVA1 radiation with wavelengths of 340-400 nm and UVA2 radiation with wavelengths of 315-340 nm, is responsible for chronic damage of the dermal connective tissue, e.g., elastosis or so-called senile atrophy of the skin with increased wrinkling. Furthermore, UVA radiation causes photodermatoses and photodynamic reactions due to interactions with pathological metabolic products and certain drugs.

The short-wave fraction of UVA2 radiation contributes to acute and chronic harmful effects. The longer-wave fraction of UVA1 radiation, on the other hand, causes hardly any damage to nucleic acid or dermal connective tissue. Where cosmetic tanning is concerned, it is important for this reason not only to administer UVB radiation in extremely well-dosed form but also to characterize the UVA2 radiation component in order to make the user aware of the danger of an emitter.

UVB radiation causes sunburn, promotes pigment formation, and leads to the development of hyperkeratosis, a natural defense mechanism of the skin to UV radiation. However, UVB radiation in uncontrolled and excessive doses also leads to problems ranging from chronic light exposure damage of the epidermis to solar-induced carcinomas. From the dermatological and pathological standpoint, medium-wave ultraviolet radiation, UVB, thus presents problems for a variety of reasons.

First, it causes sunburn if the erythema threshold, i.e., the threshold dose for triggering erythema of the skin, is exceeded. Furthermore, repeated excessive exposure of the skin to UVB radiation, even without sunburn, causes chronic light exposure damage, such as premature aging of the skin, precancerous states, or even skin cancer. Chronic light exposure damage is certain when only 60% of the erythema threshold is reached. The smallest UVB dose that just causes erythema, i.e., the erythema threshold, varies from person to person. It is strongly dependent on a person's pigmentation type and is also critically determined by the degree of development of hyperkeratosis, the natural defense of the skin to UV radiation.

UVC radiation is of no critical importance in this connection, since known UV radiation sources, such as those used in tanning salons or the like, do not contain this radiation fraction.

The individuality of the natural defense of the skin to UV radiation is the reason for the difficulties associated with determining the maximum radiation dose and/or the maximum exposure time of a subject, at which negative health consequences can be reliably ruled out. The only criteria available for establishing these maximum values are phenomenological criteria, the so-called phototype or skin type determination, in which, on the basis of a visual evaluation of the subject according to the color of the eyes and hair, the number of freckles, the color of the natural complexion and nipples, and the reaction of the skin to sun, a classification in four or sometimes five phototypes is made, which classification is then used as a measure of an allowable upper limit of a threshold radiation. For example, in the determination of the maximum exposure time, erythema-effective threshold radiation doses of 250 J/m² for phototype II, 350 J/m² for phototype III, and 450 J/m² for phototype IV are established on a largely arbitrary basis. Aside from an unverifiable classification in only four or five phototypes, no consideration whatever is given to the natural, individually variable hyperkeratosis.

In addition to this essentially arbitrary classification of the subjects in phototypes and a resulting recommendation for the maximum UV radiation dose and the maximum exposure time, the physical characteristics of the UV emitter, whether this is the sun or a tanning bed or the like, are critically important for establishing a standard for the maximum exposure time or a threshold dose. For example, natural UV radiation depends on the location, the time of day, the amount of cloud cover, etc.

Based on the classification in phototypes, allowable radiation doses of UV radiation devices are established only by guidelines, e.g., the guidelines of the FDA (Food and Drug Administration) in the USA or the guidelines of the EU Commission in Europe. For artificial UV emitters, it is further prescribed, e.g., by the Radiation Protection Commission in Germany, that devices operated and supervised by trained personnel may not exceed a measured erythemally-effective radiation (EER) of 0.3W/m² in their effective plane, which corresponds to a solar erythema factor of 1. Likewise, a total measured irradiance of 1,200 W/m² in the effective plane may not be exceeded.

On the basis of this standard, for example, a maximum exposure time of 8.33 minutes is obtained for a subject of phototype II by division of the erythemally-effective threshold radiation of 250 J/m² by the maximum radiation intensity (EER) of 0.3 W/m².

However, an exact determination of time and intensity of UV radiation in the presence of a developed hyperkeratosis, sunscreens, cosmetics or the like is practically impossible.

Furthermore, these essentially empirical allowed values do not in any way take into account the variation, especially of artificial UV emitters, e.g., due to aging, the replacement of bulbs, temperature fluctuations due to the total radiation time of a tanning bed, etc. In addition, even with the proper use and cleaning of tanning beds or the like, changes occur, for example, in the reflective behavior and the UV emission, due to curing of, for example, acrylic covering panes, so that it can scarcely be assumed that the manufacturer's specifications with respect to the spectrum and the radiant power, e.g., of a tanning bed, are still applicable.

The state of the art for the determination of the photosensitivity of the skin is limited to devices for color determination, which are known by such names as Chromameter or Mexameter. These devices use optically visible radiations, e.g., white RGB light or spectrally subdivided radiations in the red, green, yellow, or blue spectral region. However, since the scattering coefficient μs is greater than the absorption coefficient μa of the skin in these wavelength regions (cf. FIG. 3), only a direct reflection on the skin can be measured, since the measure of the superficially reflected radiation is always greater than that of the absorbed radiation. For this reason, devices of this type are not suitable for providing information about the limitation of a UV radiation dose or radiation exposure for a subject.

With this technical background in mind, an object of the invention is to develop devices and methods that provide verifiable and reproducible information about the maximum radiation dose and/or the maximum exposure time of a subject to a UV radiation emitter.

This object is achieved by a device for determining the allowable exposure time and/or radiation dose of the human skin with UV radiation, which has at least one UV emitter for emitting UV radiation, at least one UV sensor for receiving the UV radiation diffusely reflected in and/or on the skin, and an evaluation unit for determining the radiation absorption.

To this end, the UV emitter is designed in such a way that it preferably locally irradiates the human skin, e.g., it is designed as a diode that emits UV radiation. Alternatively, the UV radiation of a tanning bed or the like can be used if the emitted radiation is guided to the skin of a subject by, for example, an optical waveguide, possibly with suitable filtering devices.

The UV radiation that penetrates the skin, in which it is scattered and then diffusely reflected, is received by the UV sensor, and then the radiation absorption can be determined by an evaluation unit. The absorption of the applied UV radiation in the skin typically occurs exactly in the location or in the skin layers that are important for the natural development of hyperkeratosis, by which especially the density or thickness of the layer of melanin granules and the density or thickness of the layer of the melanosomes assimilated by keratinocytes are determined.

Corresponding to the degree of diffuse reflection, e.g., set between 0% and 100%, a grid of the allowable threshold dose can be associated with this scale, and exactly one threshold dose can be reproducibly assigned according to each measurement.

Compared to the previous classification in only four or five phototypes by a visual inspection by an only semiskilled operator, the device of the invention allows much finer resolution, e.g., between 1 and 10,000, and the measurement result is especially reproducible and independent of subjective assessments. Moreover, the threshold dose is derived on the basis of the quantity of available melanin granules or melanosomes and can thus be kept well below the development of erythema.

To achieve sufficient quality of the measurement and the determination of the radiation absorption by an evaluation unit, it was found to be effective if the UV emitter emits UV radiation for which an absorption coefficient μa is greater than or equal to a scattering coefficient μs.

To this end, it is further provided that the UV emitter emit UV radiation of a wavelength smaller than the diameter of a cell nucleus. As a consequence of this, radial scattering, Rayleigh scattering, occurs in the cellular tissue, e.g., at collagen fibrils, supermolecules, or cell membranes, so that an exact thickness and density of a cellular layer, such as that of the melanin granules, can be derived from the diffuse reflection.

Due to this measure, there is an exact determination of the absorption at an area of hyperkeratosis, since in the case of longer wavelengths, corresponding to the previously known devices, scattering that is directed forward or forward and backward occurs in the visible spectrum of light at Mie scatterers, e.g., at cell nuclei, mitochondria, or organelles, which makes a determination of an area of hyperkeratosis extremely problematic, since considerable deviations of the measurement results from one another are already caused by the characteristics of the skin surface itself, applied cosmetics, variations in blood flow, etc.

If the absorption coefficient μs and the scattering coefficient μa are equal, a UV-sensitive skin can be distinguished from a less sensitive skin in a simple way. If the scattering predominates, the skin is sensitive, and if the absorption predominates, a less sensitive skin type is present. Furthermore, it is possible to make an indirect determination of the size, the formation, and the density of the melanosomes. The melanosomes with their dome-shaped formation have an average edge length of about 350 nm. If then the edge length is smaller, strong forward and strong backward scattering occurs at the melanosomes. As a result, a large portion of the measurement radiation is reflected and thus detected by the UV sensor. If the edge length is about 350 nm, highly radially pronounced scattering of the UV radiation occurs at the melanosomes, so that neighboring cells and melanosomes are also struck, and thus absorption predominates. If the edge lengths of the melanosomes are even longer, strong forward and backward scattering again occurs, but in this case most of the incident UV radiation is absorbed by the melanosomes, and as a result absorption predominates.

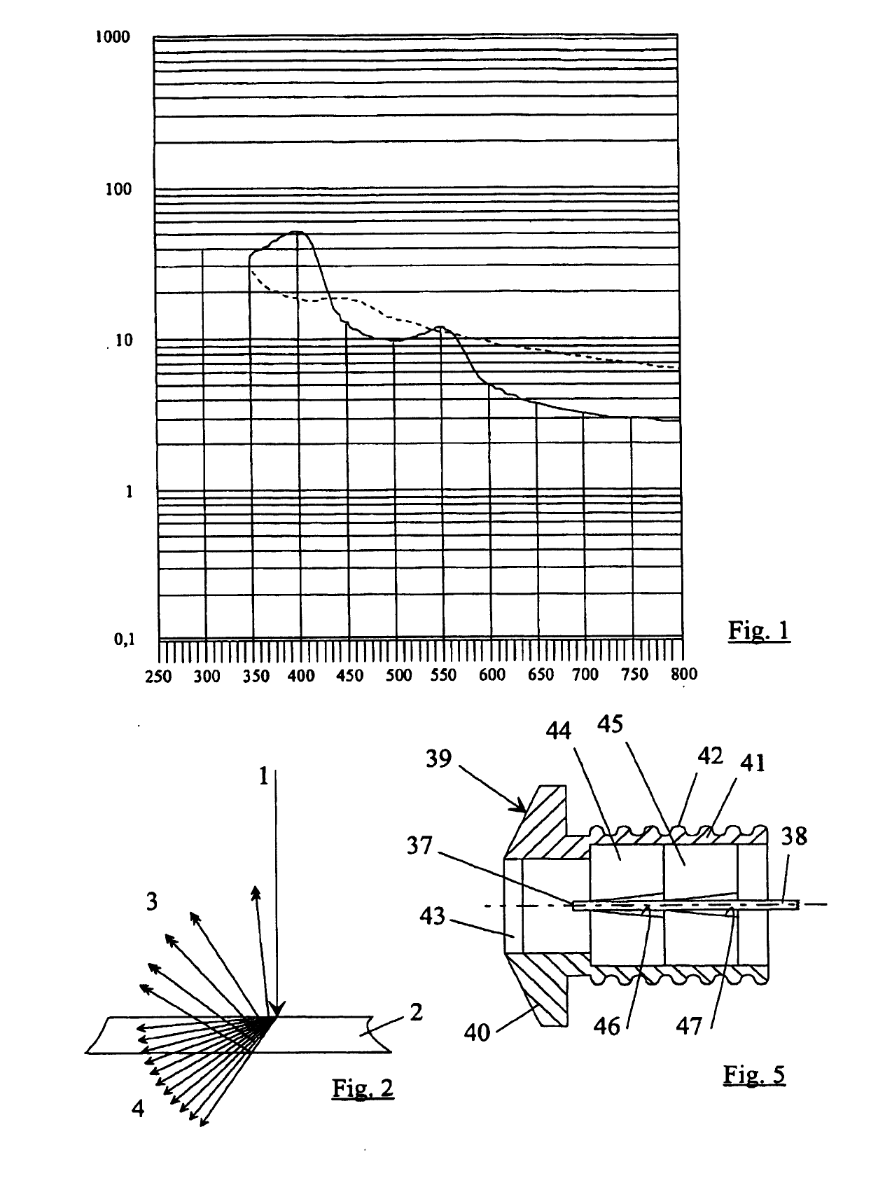

Suitable UV emitters are preferably those which emit a wavelength of 345 nm to 355 nm, and especially 350 nm. At 350 nm the absorption coefficient μa is 12.3 cm⁻¹, and the scattering coefficient μs is 12.5 cm⁻¹, so that these coefficients are almost equal, but the absorption still predominates slightly. In this regard, we can already refer to FIG. 1.

It is advantageous for the one or more UV emitters and/or the one or more UV sensors to be installed in a housing of a hand-held measuring instrument. In this regard, it is preferred for both the UV emitter and the UV sensor to be installed in a common housing, so that a measuring instrument that is independent of another radiation source is made available. Alternatively, however, the radiation source of a tanning bed or the like can also serve as the radiation source.

The instrument can be designed in such a way that the housing has an application surface for placement on the skin of the subject and that the UV emitter and the UV sensor are arranged at an angle to each other in such a way that a reflection of a ray on the optical axes of the UV emitter and the UV sensor occurs at a depth of penetration of up to 1 mm below the application surface. As a result of this measure, diffuse reflection of the UV radiation is received again by the UV sensor, which reflection reflects the formation of an area of hyperkeratosis in the critical layers of the skin, especially those in which melanins are formed or those that contain their precursors, dopamines, as well as those of the melanin granules and those of the oxidized melanins.

For tanning salons or the like, a defined penetration depth of this sort is perfectly sufficient, especially when a mean value of several measurements is taken. However, for special applications, e.g., in phototherapy, the instrument can also be designed in such a way that the depth of penetration can be adjusted. The three specified layers of the skin can then be individually and separately measured at a predetermined site in an extremely precise way, and the absorption capacity of each layer can be determined.

The design of the instrument can be modified in such a way that the optical axes of the UV emitter and the UV sensor span an angle α of 70° to 110°, and the depth of penetration can be varied by adjusting the angle α. Alternatively or additionally, the height and/or the distance of the UV emitter and the UV sensor above the application surface can be adjusted in order to vary the depth of penetration.

Since an area of hyperkeratosis does not develop uniformly over the entire surface of the skin, e.g., it is distinctly different in regions of the skin that are regularly exposed to solar radiation than in regions of the skin that are usually covered by clothing, it has been found to be effective to take a mean value of several measurements, e.g., three measurements. To this end, it is advantageous for the device to have a processor unit. The processor unit can then additionally assign a threshold dose to a measurement and/or a threshold dose is preferably assigned to the mean value of several measurements. This is always advantageous if a single UV radiation source is used.

To take into account the uncertainty factor of UV emitters, it can additionally be provided that the fraction of erythemally-effective UV radiation from a radiation source be stored in an electronic memory and that the processor unit compute the maximum exposure time and/or radiation dose. This type of data on the erythemally-effective UV radiation can be made available, e.g., by spectral measurement of the radiation source by its manufacturer.

The design of the device can be further modified by providing an interface, by which individual data of a subject can be stored and retrieved. The interface can be a chip card write and/or read device, which can then, for example, store the individual maximum exposure time and/or radiation dose on a chip card, and this data can then be read out by a control unit of a radiation source, which can then be automatically adjusted to the correct maximum exposure time and/or radiation dose. Alternatively, an interface of this type can be designed as a USB or RS-232 port, so that at least one radiation source can be operated directly or via a central computer over suitable cable connections. State-of-the-art wireless networks can also be used for this type of data transmission.

In this regard, it is also easily possible to distinguish different body regions of a subject, e.g., the torso and face, if both regions are measured separately and, for example, a tanning bed has UV emitters that can be automatically controlled independently of one another. In addition, it is conceivable that equally long exposure times can be arranged by providing different radiant powers for, in this case, two radiation sources.

If the physical changes of the UV radiation source are also to be taken into consideration, or, e.g., in the case of a tanning bed, different distributions of UV radiation along the length of the tanning bed are to be taken into consideration, it is advantageous for the device to have a housing with two pairs of UV sensors, especially in combination with the features described above, such that, in each pair, the UV sensors are oppositely oriented, and the two pairs are arranged at an angle of 90° relative to each other. Due to this measure, the UV radiation in the tanning tunnel, e.g., a tanning bed, can be measured from all sides over a circular arc of 360°. Conducted through the tanning tunnel of a tanning bed, the UV radiation can be further locally measured, so that, e.g., in the region of the head, the neck, and the legs, different radiation doses or exposure times can be easily taken into consideration in conjunction with the corresponding skin measurements.

The design of the device can be further modified in such a way that the UV sensors are directly formed as UV sensors, but preferably they are formed by free ends of optical waveguides. First, optical waveguides attenuate the received spectrum, and, second, this makes it possible for the optical waveguides, especially all four optical waveguides, to end at a common, second UV sensor.

However, a filter mimic can be assigned to the free end of an optical waveguide, especially one by which the spectral weighting of the UV emitter that is used is adapted to the erythema effect curve. In this regard, the short-wave component of the diffusely reflected radiation will experience greater reflection at the entrance to the optical waveguide than the long-wave component, and the long-wave component will also experience improved transmission.

Provision can be made for the second UV sensor to have a linear characteristic curve over the erythemally-effective spectrum.

Alternatively and preferably, however, a characteristic curve of the second UV sensor conforms to the erythemally-effective spectrum.

In either case, a reference wavelength of 350 nm is preferably provided, since many of the UV emitters in question have an emission maximum in the vicinity of this wavelength. Emission maxima of 360 nm to 370 nm have little effect on the measured value at 350 nm, since these peaks are a maximum of 20% higher than the emission value at 350 nm. This does not preclude the provision of several measuring ranges in accordance with the subdivision of the UV spectral region touched upon at the beginning.

It is advantageous for the distance between a pair of UV sensors to correspond to the height of a human body on a tanning bed, i.e., a distance of about 20-35 cm. The device of the invention can then simply be placed on the support of a tanning bed for one or preferably more than one measurement and then pushed through the tanning tunnel, thereby providing an exact distance from the upper and lower radiation sources.

Alternatively or additionally, the device can be provided with a distance measuring instrument, e.g., an ultrasonic instrument. This measure also allows exact measurement of the UV radiation source in the region of incidence of the UV radiation on the body of a subject.

In a further refinement, a temperature sensor can be provided to allow temperature compensation. In a further development of the invention, the UV emitter or emitters can then also be measured under control of the temperature sensor when the bulb wall temperature of the UV emitters, e.g., after being turned on, has reached an optimum value that corresponds to the value during the irradiation of a subject.

Data from the measurement, e.g., of a tanning bed, are advantageously stored in an assigned electronic data bank, so that the individual maximum exposure time and/or radiation dose can be computed by the processor from the individual data of the subject obtained by measurement of his skin and from the data of the UV radiation source obtained by measuring the UV radiation source, and the UV radiation source or sources are directly operated via suitable interfaces until they are automatically shut off when the threshold dose has been reached. Overdosage of UV radiation is thus virtually ruled out.

A method for determining the allowable UV exposure time and/or radiation dose of human skin, preferably with the use of one of the devices described above, is aimed at an individual measurement of the absorption of the erythemally-effective UV radiation in the layer of a subject's skin. that develops hyperkeratosis and at the assignment of a UV radiation threshold value. This irradiation can be carried out by means of direct UV irradiation, e.g., with a UV diode, or by means of an optical waveguide. Fluorescence photometry is an irradiation alternative.

It is advantageous to use a processor unit to take a mean value of several individual measurements and then to assign a threshold dose to this mean value.

Preferably, individual measurements, e.g., three individual measurements, are made at different skin sites in order to take local skin differences into account.

It is also possible to make individual measurements at different skin depths in order to determine the hyperkeratosis in specific layers of skin.

The threshold value and the stored data of a UV radiation source, e.g., a data bank, preferably data obtained from direct measurements, are then used by the processor to additionally determine a maximum exposure time or radiation dose.

The method of the invention can also be advantageously used while a subject is being irradiated. Virtually in time, both the changes in the UV radiation source(s) and in the skin of the subject are monitored, and the UV radiation source(s) are shut off when the skin's UV defense is exhausted.

The invention is explained in greater detail below with reference to the drawings, which show graphs, diagrams, and schematic illustrations of a specific embodiment of the invention.

FIG. 1 shows a graph of the scattering coefficient μs (broken curve) and the absorption coefficient μa as functions of the wavelength in nanometers.

FIG. 2 shows a diagram illustrating diffuse reflection.

FIG. 3 shows a device of the invention for determining the UV absorption of the skin and measuring a UV emitter.

FIG. 4 shows a detail view of the arrangement of a UV emitter and a UV sensor of the device of FIG. 3.

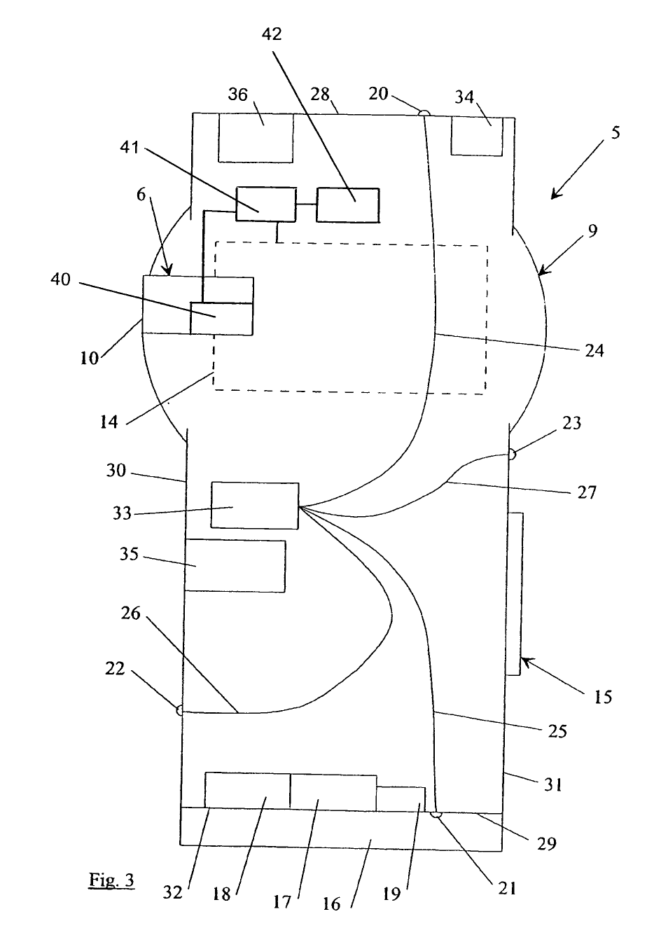

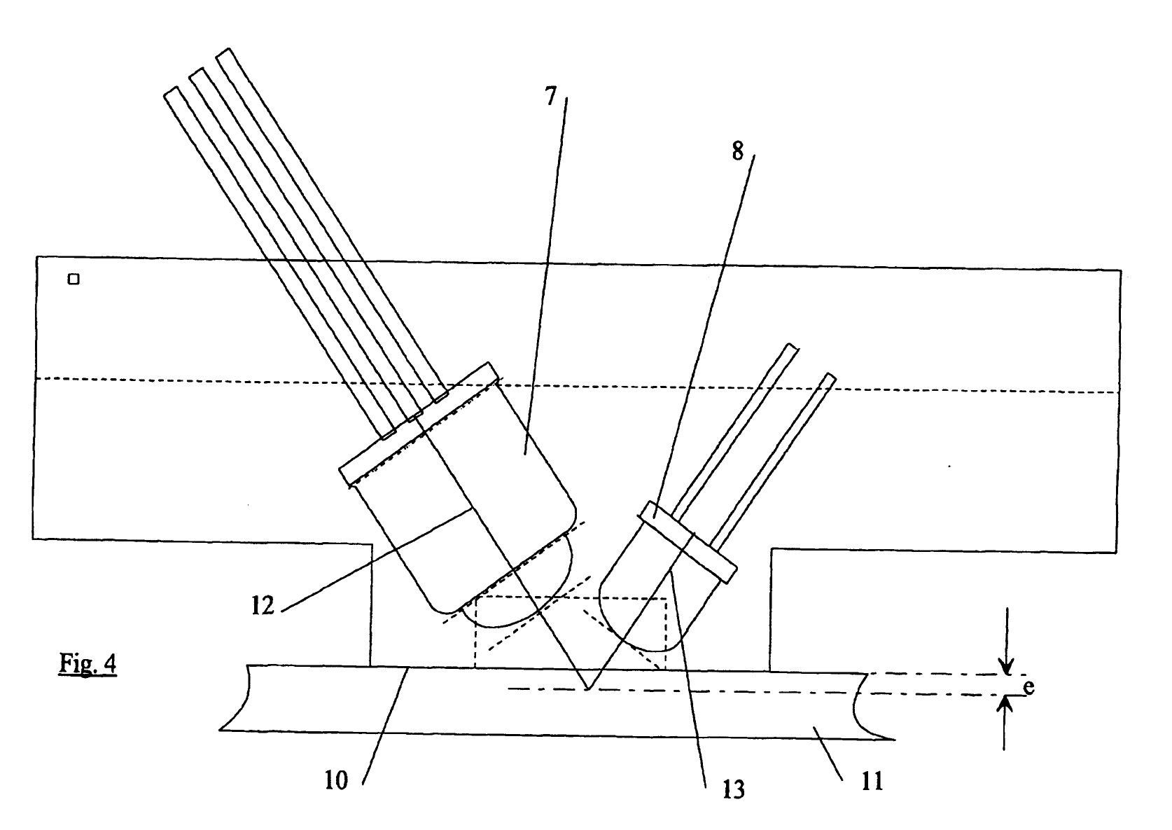

FIG. 5 shows a cross section of the free end of an optical waveguide.

FIG. 1 shows the absorption coefficient μa of dimension 1/cm (solid curve) and the scattering coefficient μs of dimension 1/cm (broken curve) as functions of the wavelength of the light in nanometers. The absorption coefficient μa has relative maxima in the blue region at about 400 nm and in the green region at about 550 nm.

In the wavelength region of 400 nm, the absorption is accounted for by the hemoglobin and thus in skin layers that are too deep to provide any information about hyperkeratosis for the UV region. In particular, when the skin is irradiated with light in the visible region, scattering occurs on Mie scatterers, which scatter essentially forwards or forwards and backwards. This is due to the greater wavelength of visible light compared to the dimensions of the absorbing structures, such as cell nuclei, mitochondria, or organelles. As a consequence, previously known devices that operate with visible light could only detect reflection. No conclusions can be drawn about the strength of an area of hyperkeratosis, since measurement results of this type are already considerably distorted by the characteristics of the skin surface itself, applied cosmetics, variations in blood flow, and many other factors, which is compensated by large tolerances and oversized measuring windows of the previously known devices.

In accordance with the invention, the determination of the allowable exposure time and/or radiation dose is based on UV radiation, which preferably has a wavelength of 345 nanometers to 355 nanometers, and especially a wavelength of 350 nanometers. FIG. 1 shows that at this wavelength the scattering coefficient μs, with a value of 12.3 cm⁻¹, is practically the same as the absorption coefficient μa, with a value of 12.5 cm⁻¹, even though the absorption predominates at this wavelength.

Due to the selected wavelength, the reflection that occurs in and/or on the skin is not true reflection but rather diffuse reflection. In this process, an incident ray of light 1 in FIG. 2 penetrates the skin 2 and is radially scattered on Rayleigh scatterers due to the selected wavelength and is partly diffusely reflected, as indicated by the rays of light 3, and partly absorbed, as indicated by the rays 4.

The density and/or the thickness of the melanin granules and/or the density and/or thickness of the layer of melanosomes embedded in keratinocytes can be derived from the rays 3 that represent diffuse reflection in order to obtain information about the effectiveness of an area of hyperkeratosis, on the basis of which a threshold dose can then be determined. The threshold dose should be well below the erythemogenic dose in order to safely rule out damage.

An individual measurement of the absorption of the erythemally-effective UV radiation in a layer of the skin of a subject in which hyperkeratosis has developed can be taken, and then a UV radiation threshold value can be assigned to these measurements by a processor unit, with the UV irradiation being carried out directly or by means of fluorescence photometry.

It is advantageous to compute a mean value of several individual measurements at different sites, so that a threshold value can be assigned to an average value of the skin, possibly for differently irradiated parts of the body.

The measuring method is carried out with a device 5 according to FIG. 3, which shows a merely schematic illustration of the device. The device in FIG. 3 has a measuring device 6 with an evaluation unit (not shown) for determining radiation absorption. The device has a UV emitter 7 (FIG. 4), e.g., in the form of a diode, for emitting UV radiation and a UV sensor 8 for receiving the UV radiation diffusely reflected in and/or on the skin. The UV emitter 7 and the UV sensor 8 are arranged in a common housing 9 of the device 5, which is designed as a hand-held measuring instrument.

For the measurement of the skin, the measuring device 6 or the device 5 has an application surface 10, which is placed on the skin 11 of a subject (see FIG. 4). This ensures that the UV emitter 7 and the UV sensor 8 are always correctly positioned relative to the skin 11.

For operation, e.g., in tanning salons or the like, it is sufficient if the layers of the skin in which hyperkeratosis develops are measured at a depth of about 0.5 mm to 1 mm, i.e., a reflection of a ray on the optical axis 12 of the UV emitter 7 and the optical axis 13 of the UV sensor 8 occurs at a depth of penetration “e” of up to 1 mm below the application surface 10.

Provision can be made, e.g., in an individual measurement of skin layers of very different thickness or for sensitive phototherapy, to measure different skin layers and therefore to make the depth of penetration variably adjustable, e.g., by making it possible to adjust the height and/or the distance of the UV emitter 7 and the UV sensor 8 above the application surface 10 or by making it possible to adjust the angle α between the optical axes 12, 13, which has values especially of 70-110°.

A processor unit (not shown) preferably computes a mean value of several measurements on the skin by the measuring device 6 and assigns a threshold dose to this mean value. This can be displayed on a display 14.

However, it is advantageous to store the fraction of the erythemally-effective UV radiation intensity of one or more radiation sources in an electronic memory (not shown) in the device 5 or in an external memory, and, after selection of the radiation source, the processor unit can compute the maximum exposure time and/or radiation dose and display it on the display 14.

To this end, the device 5 also has three interfaces, by which, first of all, the individual data of a subject and/or the data of a UV emitter could be externally stored and retrieved. Furthermore, provision can be made to operate one or more radiation sources via one of these interfaces and possibly via a central computer as well, and to preset the computed maximum exposure time and/or radiation dose in this way.

Since tanning salons often use chip card systems for their accounts, an interface of this type can be a chip card read/write device 15, which is indicated here merely as a slot.

An interface of this type can be, for example, an RS-232 port 17 and/or a USB port 18 for direct connection to a computer, and a reset switch 19 can also be provided, and it is advantageous to cover all of these components with a cap 16 to protect them from dirt. Alternatively or additionally, wireless interfaces can also be used.

Rather than storing data of a tanning bed or the like according to the manufacturer's specifications, it is more advantageous to measure this data individually in order to reliably detect changes in the radiation possibly resulting from aging, dirt, etc. To this end, the device 5 also has two pairs of UV sensors 20-23, which are formed by the free ends of optical waveguides 24-27 and are oriented in opposite parallel housing walls 28-31 of the essentially rectangular housing 9 of the illustrated embodiment in such a way that the members of each pair of UV sensors 20, 21 and 22, 23 are oppositely oriented, and the pairs of UV sensors 20, 21 and 22, 23 are also arranged at an angle of 90° relative to each other. This makes it possible to measure the radiation over a complete circular arc of 360° essentially in one plane.

The free end 37 of an optical waveguide 38 can be arranged inside a housing 39, whose shape largely conforms to that of a signal lamp, which has a head 40 and a base 41 with an outer thread 42 and is to be installed in a panel (see FIG. 5). The housing 39 also holds a filter mimic, which is assigned to the free end 37 of the optical waveguide. In the embodiment shown in FIG. 5, the filter mimic consists of a plastic disk 43 held free in front of the end 37 of the optical waveguide 38 by the head 40 and two other plastic disks 44, 45, which are pushed onto the optical waveguide 38 and held by the base 41 and for this purpose are provided with central, conical holes. This filter mimic causes reflection of the short-wave component of the diffusely reflected radiation and also causes the long-wave component to experience improved transmission.

Since the distance between the two UV sensors 20, 21 is approximately equal to the height of a human body on a tanning bed, i.e., about 20-35 cm, the housing wall 29 of device 5, which housing wall 29 is designed as a flat base for this purpose, can be easily moved on the support surface of a tanning bed (after the cap 16 has been removed), in order, for example, to undertake several measurements along the length of the tanning bed, e.g., in the head, neck, or leg region.

The incident UV radiation is received by the UV sensors 20-23 and fed to a common, second UV sensor 33, so that a mean value of the radiation intensity can be formed, and in this connection it is conceivable that different measurement ranges over the UV spectrum can be provided.

The measured radiant power of a tanning bed then serves as the basis for computing the maximum exposure time, for which purpose this data can be stored internally in the device or externally and can subsequently be retrieved via an interface 15, 17, 18.

In addition, a distance measuring instrument 34 can also be provided, so that the correct distance to a radiation source can always be maintained.

A temperature sensor 35 also allows different temperatures to be considered, e.g., after a long or short time of operation of an emitter. In particular, the temperature sensor 35 allows measurement of a UV radiation source only after its bulb wall temperature has reached a standard temperature.

The device of the invention is preferably powered by rechargeable batteries, which are recharged via a plug connector 36 for a power pack.

1-38. (canceled)

39. A device for determining an allowable UV exposure time or allowable UV radiation dose for human skin, comprising:
a UV emitter for emitting UV radiation on the skin;
a UV sensor for receiving UV radiation diffusely reflected by the skin; and
an evaluation unit coupled to the UV emitter and the UV sensor for determining UV radiation absorption of the skin based on the UV radiation emitted on the skin by the UV emitter and the UV radiation received by the UV sensor.

40. The device of claim 39, wherein the UV emitter emits UV radiation for which the skin has an absorption coefficient μa greater than or equal to a scattering coefficient μs.

41. The device of claim 39, wherein the UV emitter emits UV radiation having a wavelength smaller than the diameter of a skin cell nucleus.

42. The device of claim 39, wherein the UV emitter emits UV radiation having a wavelength of approximately 345 nm to 355 nm.

43. The device of claim 39, wherein the UV emitter and the UV sensor are disposed in a housing of a hand-held instrument.

44. The device of claim 43, wherein the housing has an application surface for placement on the skin, each of the UV emitter and the UV sensor has an optical axis, and the UV emitter and the UV sensor are disposed at an angle relative to each other so that a reflection of a ray on the optical axes of the UV emitter and the UV sensor occurs at a depth of penetration of up to approximately 1 nm below the application surface.

45. The device of claim 44, wherein the depth of penetration can be varied.

46. The device of claim 44, wherein the optical axes of the UV emitter and the UV sensor span an angle of approximately 70° to 110°.

47. The device of claim 46, wherein the angle of the optical axes can be adjusted to vary the depth of penetration.

48. The device of claim 44, wherein each of the UV emitter and the UV sensor is disposed at a distance above the application surface, and the distance can be adjusted to vary the depth of penetration.

49. The device of claim 39, further comprising a processor unit coupled to the evaluation unit and operable to compute a mean value of a plurality of determinations of UV radiation absorption of the skin.

50. The device of claim 49, wherein the processor unit is operable to assign a threshold UV radiation dose to a single determination of UV radiation absorption of the skin or the mean value of a plurality of determinations of UV radiation absorption of the skin.

51. The device of claim 50, further comprising an electronic memory coupled to the processor unit and operable to store a fraction of erythemally-effective UV radiation from a UV radiation source, and the processor unit is operable to compute a maximum UV exposure time or UV radiation dose from data of the UV radiation source and the threshold UV radiation dose.

52. The device of claim 39, further comprising an interface for storing and retrieving data.

53. The device of claim 52, wherein the interface can be used to operate a UV radiation source.

54. The device of claim 44, wherein the housing has two pairs of UV sensors, the two UV sensors in each pair are oppositely disposed, and the two pairs of UV sensors are disposed at an angle of approximately 90° relative to each other.

55. The device of claim 54, further comprising four optical waveguides, each of the optical waveguides has a free end, and the two pairs of UV sensors are formed by the free ends of the optical waveguides.

56. The device of claim 55, wherein each of the free ends of the optical waveguides has a filter minic operable to cause a short-wave component of a diffusely reflected UV radiation to be reflected to a greater extent than a long-wave component of the diffusedly reflected UV radiation.

57. The device of claim 55, wherein each of the optical waveguides is connected to a common UV sensor.

58. The device of claim 57, wherein the common UV sensor has a linear characteristic curve over an erythema-effective spectrum.

59. The device of claim 57, wherein the common UV sensor has a characteristic curve conforming to an erythema-effective spectrum.

60. The device of claim 54, wherein a distance between the two UV sensors of one pair of the two pairs of UV sensors is approximately equal to a height of a human body lying on a tanning bed.

61. The device of claim 39, further comprising a distance measuring instrument for maintaining a predetermined distance between a UV radiation source and the skin.

62. The device of claim 39, further comprising a temperature sensor.

63. The device of claim 62, wherein the temperature sensor is coupled to the evaluation unit and is operable to initiate a UV radiation absorption determination of the skin when an optimum bulb wall temperature of a UV radiation source to be measured in a tanning bed is reached.

64. The device of claim 57, further comprising a data bank coupled to the common sensor for storing data received by the common sensor.

65. The device of claim 49, wherein the processor unit computes a maximum UV exposure time or UV radiation dose from individual data of a human being and of a UV radiation source.

66. The device of claim 65, wherein when the maximum UV exposure time or UV radiation dose is reached, the UV radiation source is shut off.

67. A method of determining an allowable UV exposure time or allowable UV radiation dose for human skin, comprising:
determining absorption of erythemally-effective UV radiation in a layer of the skin that has developed hyperkeratosis; and
assigning a UV radiation threshold value to the determination of UV radiation absorption of the skin.

68. The method of claim 67, wherein the UV radiation is carried out by means of direct UV irradiation.

69. The method of claim 67, wherein the UV radiation is carried out by means of fluorescence photometry.

70. The method of claim 67, wherein a mean value of a plurality of determinations of UV radiation absorption of the skin is taken, and a UV radiation threshold value is assigned to the mean value.

71. The method of claim 70, wherein the determinations are made at different sites of the skin.

72. The method of claim 70, wherein the determinations are made at different depths of the skin.

73. The method of claim 67, wherein a maximum UV exposure time or UV radiation dose is determined from the threshold value and stored data of a UV radiation source.

74. The method of claim 73, wherein the stored data are data derived from a measurement of the UV radiation source.

75. The method of claim 67, wherein the method is used during a UV irradiation treatment of a human being.

76. The method of claim 67, wherein the method is carried out by using a device comprising a UV emitter for emitting UV radiation on the skin, a UV sensor for receiving UV radiation diffusely reflected by the skin, and an evaluation unit coupled to the UV emitter and the UV sensor for determining UV radiation absorption of the skin based on the UV radiation emitted on the skin by the UV emitter and the UV radiation received by the UV sensor.
